(19) United States
(12) Patent Application Publication
(10) Pub. No.: US 2014/0184188 A1
(43) Pub. Date: Jul. 3, 2014

(54) POWER CONVERSION DEVICE

(71) Applicant: FUJI ELECTRIC CO., LTD, Kawasaki-shi (JP)

(72) Inventors: Akihiro ODAKA, Hino-city (JP); Akio TOBA, Hino-city (JP); Masakazu GEKINOZU, Matsumoto-city (JP)

(73) Assignee: FUJI ELECTRIC CO., LTD, Kawasaki-shi (JP)

(21) Appl. No.: 14/197,397

(22) Filed: Mar. 5, 2014

Related U.S. Application Data
(63) Continuation of application No. PCT/JP2012/052945, filed on Feb. 9, 2012.

(30) Foreign Application Priority Data
Sep. 29, 2011 (JP) 2011-214232

(51) Int. Cl. H02M 3/156

(52) U.S. Cl. CPC H02M 3/156
USPC 323/290

(57) ABSTRACT

In some aspects of the invention, a power conversion device includes a semiconductor switch series circuit configured by connecting semiconductor switches in series, a capacitor series circuit configured by connecting capacitors in series, a reactor L connected between the series connection point of the semiconductor switches and the series connection point of the capacitors and a direct current power source connected in parallel to the capacitor. The semiconductor switch series circuit and capacitor series circuit are connected in parallel, a load is connected between the parallel connection points of the two circuits and the semiconductor switches are turned on and off, thereby raising a direct current power source voltage and supplying it to the load. By way of some aspects of the invention, it is possible to reduce the size and cost of a device.

### CROSS-REFERENCE TO RELATED CASES

This application is a continuation of International Application No. PCT/JP2012/52945, filed on Feb. 9, 2012, which is based on and claims priority to Japanese Patent Application No. JP 2011-214232, filed on Sep. 29, 2011. The disclosure of the Japanese priority application and the PCT application in their entirety, including the drawings, claims, and the specification thereof, are incorporated herein by reference.

### BACKGROUND

1. Field of the Invention

The present invention relates to a power conversion device which converts direct current power source voltage to a desired magnitude of direct current voltage by turning on and off semiconductor switches, and exchanges direct current power between a direct current power source and a load.

2. Related Art

FIG. 4 is a circuit diagram of a power supply device described in Japanese Patent Application Publication No. JP-A-2010-166646 (see paragraphs [00161-10024] and FIGS. 1 and 2), which is commonly called a DC-DC (Direct Current—Direct Current) converter.

In FIG. 4, Vₛ is a direct current power source such as a secondary battery, SW is a main switch, Cₛ and C_{d1} are smoothing capacitors, L is a reactor, Sₚ and Sₙ are semiconductor switches, Tₚ and Tₙ are power semiconductor switching elements such as IGBTs (Insulated Gate Bipolar Transistors), Dₚ end Dₙ are free wheeling diodes, and Load is a load represented as a current source.

In this heretofore known technology, accumulation and release of energy into and from the reactor L is repeated by alternately turning on and off the switching elements Tₚ and Tₙ at an appropriate time ratio, thus raising a power source voltage Vᵢₙ to a voltage Vₒᵤₜ higher than the power source voltage Vᵢₙ and supplying the voltage Vₒᵤₜ to the load Load.

When a current I_{Load} flowing through the load Load flows in a direction opposite to the direction shown in FIG. 4, the switching elements Tₚ and Tₙ are turned on and off at an appropriate time ratio so that the voltage Vₒᵤₜ applied to the load Load is of reverse polarity. In this case, as the current I_{L} of the reactor L flows in a direction opposite to the direction shown in FIG. 4, the power of the load Load is regenerated by the direct current power source Vₛ. In this way, with the heretofore known technology of FIG. 4, it is possible to realize a bidirectional power flow.

Herein, pulsating components are contained in the current I_{L} flowing through the reactor L by turning on and off the switching elements Tₚ and Tₙ. However, as the pulsating components are suppressed by the current smoothing effect of the capacitor Cₛ, a current with the pulsating components removed therefrom flows through the direct current power source Vₛ.

In general, when a current containing many pulsating components flows through a secondary battery, it reduces the life span of the secondary battery. Consequently, considering that the direct current power source Vₛ is configured of a secondary battery, it is possible, by providing the capacitor Cₛ, as shown in FIG. 4, to suppress the pulsating components of the current flowing through the secondary battery, thus lengthening the life span of the secondary battery.

Meanwhile, in FIG. 4, the main switch SW, being for electrically disconnecting the direct current power source Vₛ from a power conversion circuit formed of the semiconductor switches Sₚ and Sₙ and the like, acts so as to interrupt power source supply when an anomaly occurs in the power conversion circuit or load Load. Herein, as the main switch SW has to consume inductive energy accumulated in the reactor L, the tolerance of inductance which can be connected to the main switch SW is normally prescribed in advance for the main switch SW.

In this case, when an inductance exceeding the heretofore mentioned tolerance is connected to the switch SW, there arises a problem of causing a reduction in the life span of the switch SW, or the like. In order to respond to this problem too, however, the capacitor Cₛ absorbs the energy accumulated in the reactor L, and it is thereby possible to prevent a reduction in the life span of the switch SW.

As heretofore described, the capacitor Cₛ provided on the input side of the power conversion circuit has the function of suppressing pulsating components of the power source current and absorbing the energy accumulated in the reactor L, thereby yields the operational advantage of lengthening the life span of the direct current power source Vₛ and switch SW.

However, the capacitor Cₛ and the high voltage capacitor C_{d1} in charge of the output voltage Vₒᵤₜ cause an increase in size and cost, and it has been required to solve this problem.

Therefore, a problem to be solved by the invention lies in providing a power conversion device enabling a reduction in the size and cost of the entire device.

### SUMMARY OF INVENTION

In order to solve the heretofore described problem, in an aspect of the invention according to claim 1, a power conversion device includes a semiconductor switch series circuit configured by connecting first and second semiconductor switches in series; a capacitor series circuit configured by connecting first and second capacitors in series; a reactor connected between the series connection point of the first and second semiconductor switches and the series connection point of the first and second capacitors; and a direct current power source connected in parallel to the first capacitor or second capacitor.

Further, the device is such that the semiconductor switch series circuit and capacitor series circuit are connected in parallel, and a load is connected between the parallel connection points of the two circuits, and that direct current power is exchanged between the direct current power source and load by turning on and off the first and second semiconductor switches.

In another aspect of the invention, the power conversion device includes voltage detection means (voltage detector) which detects the respective voltages of the first and second capacitors; means which generates (voltage generator) a voltage command value of the other capacitor from a difference between an output voltage command value and a voltage detection value of one capacitor connected in parallel to the direct current power source; first regulation means (first regulator) which generates a command value for causing a voltage detection value of the other capacitor to coincide with the voltage command value of the other capacitor; and means which regulates the voltage (first voltage regulator) of the other capacitor by turning on and off the first and second semiconductor switches based on the command value output from the first regulation means.

In another aspect of the invention, the power conversion device includes current detection means (current detector) which detects a current flowing through the reactor; second regulation means (second regulator) which generates a command value for causing a current detection value detected by the current detection means (current detector) to coincide with a current command value output from the first regulation means; and means which regulates the voltage (second voltage regulator means) of the other capacitor by turning on and off the first and second semiconductor switches based on the command value output from the second regulation means (second regulator).

The power conversion device of the invention is of a circuit configuration wherein the voltage of a capacitor, of a capacitor series circuit, to which a direct current power source is not connected in parallel is regulated by turning on and off semiconductor switches, thus controlling direct current output voltage to a predetermined value. Because of this, it is possible to use a low voltage capacitor as the heretofore mentioned capacitor, thus contributing to a reduction in the size and cost of the entire device.

### BRIEF DESCRIPTION OF DRAWINGS

FIG. 1 is a circuit diagram showing a first embodiment of the invention;

FIG. 2 is a circuit diagram showing a second embodiment of the invention;

FIG. 3 is a circuit diagram showing a third embodiment of the invention; and

FIG. 4 is a circuit diagram showing a heretofore known technology.

### DETAILED DESCRIPTION

Hereafter, a description will be given, along the drawings, of embodiments of the invention.

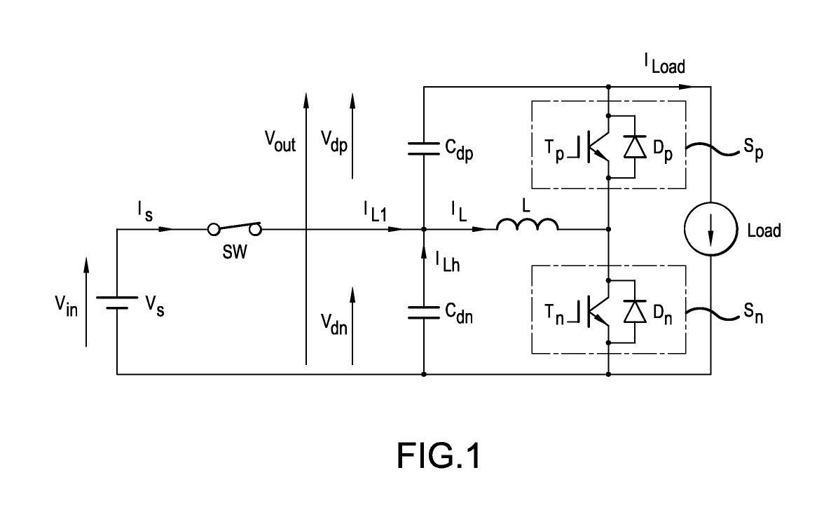

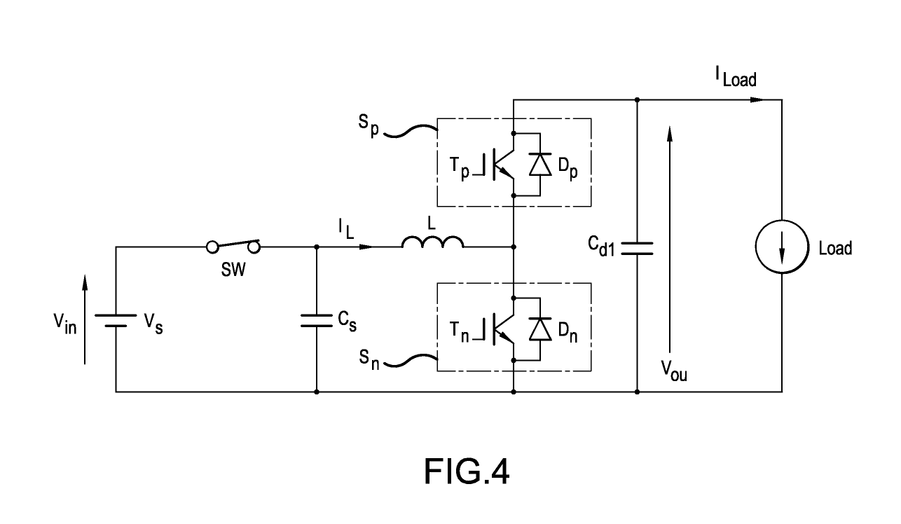

Firstly, FIG. 1 is a circuit diagram showing a first embodiment of the invention corresponding to claim 1, wherein components having the same functions as in FIG. 4 are given the same reference signs and a description will be omitted, and hereafter, a description will be given centering on portions different from those of FIG. 4.

In FIG. 1, a capacitor series circuit wherein first and second capacitors C_{dp} and C_{dn} are connected in series and a semiconductor switch series circuit wherein first and second semiconductor switches Sₚ and Sₙ are connected in series are connected in parallel, a load Load is connected between the parallel connection points of the two circuits. Also, a reactor L is connected between the series connection point of the capacitor series circuit and the semiconductor switch series circuit, and a direct current power source Vₛ, such as a secondary battery, is connected in parallel to the second capacitor C_{dn} via a main switch SW.

Although not shown, the direct current power source Vₛ may be connected in parallel to the first capacitor C_{dp}, rather than the second capacitor C_{dn}, via the switch SW.

According to this circuit configuration, it is possible to raise and lower a voltage V_{dp} of the capacitor C_{dp} with respect to a power source voltage Vᵢₙ in by turning on and off switching elements Tₚ and Tₙ. Herein, a voltage applied to the load Load, that is, an output voltage Vₒᵤₜ in the invention is the sum of the voltage V_{dp} of the capacitor C_{dp} and a voltage V_{dn} of the capacitor C_{dn}, and the voltage V_{dn} of the capacitor C_{dn} is equal to the power source voltage Vᵢₙ.

Because of this it is possible to supply a voltage equal to or higher than the power source voltage Vᵢₙ to the load Load as the output voltage Vₒᵤₜ by regulating the voltage V_{dp} of the capacitor C_{dp} by turning on and of the switching elements Tₚ and Tₙ.

Herein, when the on time ratio of the switching element Tₙ is taken to be α, the relationship between the voltage V_{dp} of the capacitor C_{dp} and the power source voltage Vᵢₙ can be expressed by Formula 1. Consequently, it is possible to regulate the voltage V_{dp} of the capacitor C_{dp} and thus the output voltage Vₒᵤₜ to a predetermined value by controlling the on time ratio α, in other words, the turning on and off of the switching elements Tₚ and Tₙ.

$${V}_{dp} = \frac{α}{1 - α} {V}_{in} \qquad [ Formula 1 ]$$

Now, in this embodiment, a current I_{L} flowing through the reactor L is the sum of a current I_{L1} flowing through the direct current power source Vₛ and a current I_{Ln} flowing through the capacitor C_{dn}. When taking into account the impedance of the wiring between the direct current power source Vₛ and capacitor C_{dn} or the internal impedance of the power source Vₛ (these impedances are not shown), pulsating components contained in the current I_{L} flowing through the reactor L flow through the capacitor C_{dn} as the I_{Ln}, and only average components of the current I_{L} flow through the direct current power source Vₛ as an I_{L1}.

It is also conceivable from a different angle that this is because a kind of filter for suppressing the pulsating components is formed by the wiring impedance or the internal impedance of the power source Vₛ and the capacitor C_{dn}.

Hereafter, a description will be given of operational advantages of this embodiment while comparing them with those of the heretofore known technology f FIG. 4.

Firstly, consideration will be given, focusing on capacitors which suppress the pulsating components of the current I_{L} flowing through the reactor L. In FIGS. 1 and 4, when filtering ability determined by capacitance is taken to be the same, the capacitor C_{dn} in FIG. 1 and the capacitor Cₛ in FIG. 4 are equal in both capacitance and breakdown voltage, meaning that the replacement of the capacitor Cₛ of FIG. 4 by the capacitor C_{dn} of FIG. 1 does not directly contribute to a reduction in the size or the like of the capacitors.

Meanwhile, when comparing the functions of capacitors which exchange direct current power with the load Load, the capacitors C_{dp} and C_{dn} contribute to the power exchange in FIG. 1, and a capacitor C_{d1} contributes to the power exchange in FIG. 4. Herein, as the capacitors C_{dp} and C_{dn} are connected in series, the series combined capacitance of the capacitors C_{dp} and C_{dn} appear to be low in FIG. 1. However, in FIG. 1, as the capacitor C_{dn} is connected in parallel to the direct current power source Vₛ, it may be considered that the capacitor C_{dn} has sufficiently high capacitance with regard to the power exchange with the load Load, and it is sufficient to consider only the capacitance of the capacitor C_{dp} with regard to the power exchange with the load Load.

Because of this, it is possible to make the capacitance of the capacitor C_{dp} of FIG. 1, which is designed in accordance with the magnitude of the power exchanged with the load, equal to that of the capacitor C_{d1} of FIG. 4. Moreover, in FIG. 1, as the voltage V_{dp} of the capacitor C_{dp} is always equal to or lower than an output voltage Vₒᵤₜ, as compared with the capacitor C_{d1} of FIG. 4, it is possible to use a low voltage part as the capacitor C_{dp}. As a result, it is possible to reduce the size and cost of the capacitor C_{dp} and thus of the entire device.

To rephrase the heretofore described point, in FIG. 4, the capacitor C_{d1} contributes to the power exchange with the load Load, while in FIG. 1, the series circuit of the direct current power source Vₛ and capacitor C_{dp} contributes to the power exchange.

Consequently, supposing that it is intended to raise the power source voltage Vᵢₙ by α and supply it to the load Load, in FIG. 4, the capacitor C_{d1} has to be in charge of the whole voltage (Vᵢₙ+α) after being raised, while in FIG. 1, the capacitor C_{dp} has only to be in charge of α. Therefore, in FIG. 1, it is possible to use the capacitor C_{dp} with breakdown voltage lower than that of the capacitor C_{d1} of FIG. 4. Because of this, according to this embodiment, it is possible to reduce the size and cost of the capacitors by lowering the breakdown voltage of the capacitors.

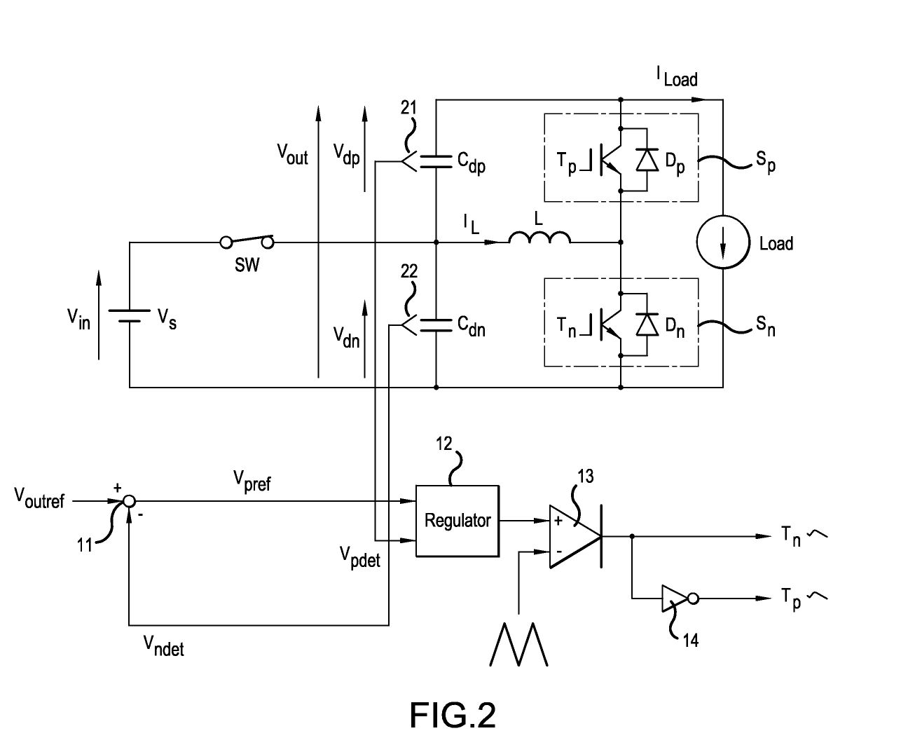

Next, FIG. 2 is a circuit diagram showing a second embodiment of the invention corresponding to claim 2. The second embodiment is configured by adding a control block to the first embodiment of FIG. 1.

In FIG. 2, a difference between an output voltage command value V_{outref} and a voltage detection value V_{ndet} of the capacitor C_{dn} detected by a voltage detector 22 is computed by a subtractor 11, and the difference is a voltage command value V_{pref} of the capacitor C_{dp}. The voltage command value V_{pref} and a voltage detection value V_{pdet} of the capacitor C_{dp} detected by a voltage detector 21 are input into a first regulator 12, and a command value for causing the voltage detection value V_{pdet} to coincide with the voltage command value V_{pref} is output from the regulator 12.

The command value output from the regulator 12 is input into the non-inverting input terminal of a comparator 13, and the input command value is compared with a triangular wave input into the inverting input terminal. Further, the output of the comparator 13 is a drive signal of the switching element Tₙ, and the output passing through a NOT circuit 14 is a drive signal of the switching element Tₚ.

With the heretofore described configuration, it is possible to control the voltage V_{dp} of the capacitor C_{dp} to a desired value, and as a result, it is possible to cause the output voltage Vₒᵤₜ to coincide with the output voltage command value V_{outref}.

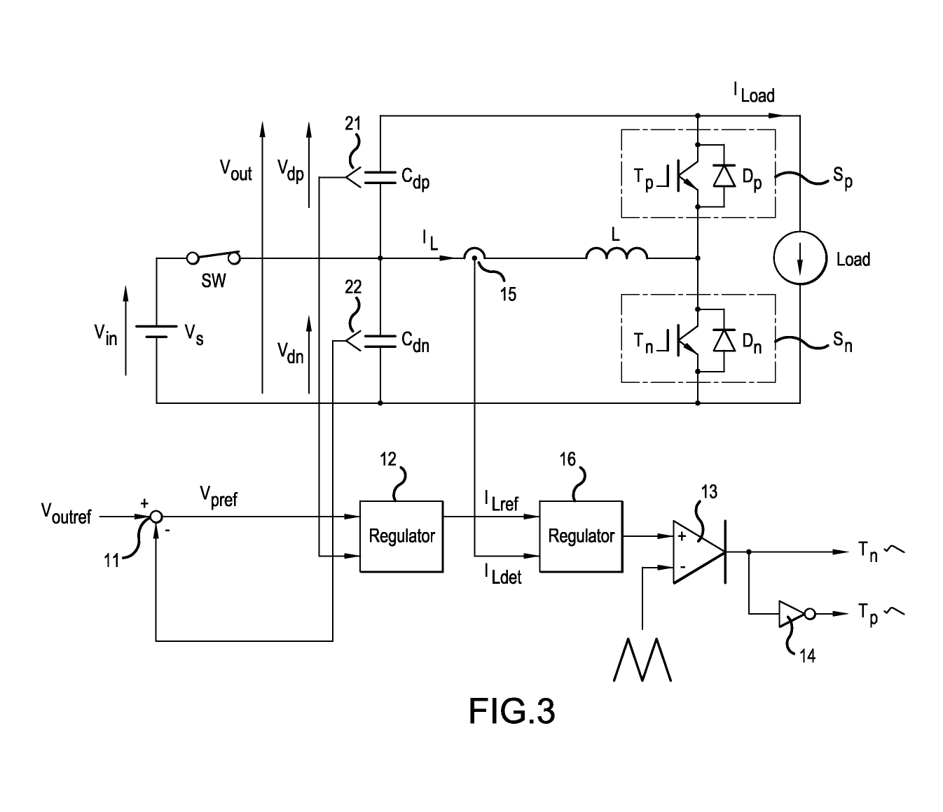

Next, FIG. 3 is a circuit diagram showing a third embodiment of the invention corresponding to claim 3.

The difference of the third embodiment from the second embodiment is that a current detector 15 which detects the current I_{L} flowing through the reactor L is provided, and a second regulator 16 which generates a command value such that a current detection value I_{Ldet} of the current I_{L} coincides with a current command value I_{Lref} output from the first regulator 12 is provided. That is, the output of the second regulator 16 into which are input the current detection value I_{Ldet} and current command value I_{Lref} is input into the non-inverting input terminal of the comparator 13 as a command value, and subsequently, the drive signals of the switching elements Tₙ and Tₚ are generated by the same operation as in the second embodiment.

According to this embodiment, the command value for causing the current detection value I_{Ldet} of the reactor L to coincide with the current command value I_{Lref} is generated by the second regulator 16, and the switching elements Tₚ and Tₙ are turned on and off based on the command value. In this case too, it is possible to control the voltage V_{dp} of the capacitor C_{dp} to a desired value, and thereby cause the output voltage Vₒᵤₜ to coincide with the output voltage command value V_{outref}, in the same way as in the second embodiment.

With the third embodiment, as a current flowing into the capacitor C_{dp} is controlled, it is possible to improve responsiveness as compared with the second embodiment.

The invention, being optimum for use in a case in which a reduction in size is strongly required due to limitations of installation space, can be utilized as an on-vehicle type power conversion device for an electric vehicle, hybrid vehicle, or the like.

What is claimed is:

1. A power conversion device including:
a semiconductor switch series circuit configured by connecting first and second semiconductor switches in series;
a capacitor series circuit configured by connecting first and second capacitors in series;
a reactor connected between the series connection point of the first and second semiconductor switches and the series connection point of the first and second capacitors; and
a direct current power source connected in parallel to the first capacitor or second capacitor, wherein
the semiconductor switch series circuit and capacitor series circuit are connected in parallel, and a load is connected between the parallel connection points of the two circuits, and
direct current power is exchanged between the direct current power source and load by turning on and off the first and second semiconductor switches.

2. The power conversion device according to claim 1, further comprising:
a voltage detector which detects the respective voltages of the first and second capacitors;
a voltage generator which generates a command value of the other capacitor from a difference between an output voltage command value and a voltage detection value of one capacitor connected in parallel to the direct current power source;
a first regulator which generates a command value for causing a voltage detection value of the other capacitor to coincide with the voltage command value of the other capacitor; and
a first voltage regulator which regulates the voltage of the other capacitor by turning on and of the first and second semiconductor switches based on the command value output from the first regulator.

3. The power conversion device according to claim 2, further comprising:
a current detector which detects a current flowing through the reactor;
a second regulator which generates a command value for causing a current detection value detected by the current detector to coincide with a current command value output from the first regulator; and
a second voltage regulator which regulates the voltage of the other capacitor by turning on and off the first and second semiconductor switches based on the command value output from the second regulator.
